(19) United States
(12) Patent Application Publication
(10) Pub. No.: US 2013/0161139 A1
(43) Pub. Date: Jun. 27, 2013

(54) DAMPING CYLINDER

(71) Applicants: Dieter Immler, Merlingen (DE); Franz Hirschmann, Ruteshelm (DE); Wolfgang Sedlacek, Stuttgart (DE)

(72) Inventors: Dieter Immler, Merlingen (DE); Franz Hirschmann, Ruteshelm (DE); Wolfgang Sedlacek, Stuttgart (DE)

(21) Appl. No.: 13/821,902

(22) PCT Filed: Sep. 24, 2011
(86) PCT No.: PCT/EP2011/066624

§ 371 Date: Mar. 8, 2013

Related U.S. Application Data
(60) Provisional application No. 61/387,080, filed on Sep. 28, 2010.

(51) Int. Cl. F16F 9/516

(52) U.S. Cl. CPC F16F 9/516
USPC 188/282.1

(57) ABSTRACT

A damping cylinder (100) is provided. The damping cylinder (100) comprises a housing (101) and a piston cylinder (201) located within the housing (101). A piston rod (103) extends from the housing (101) and the piston cylinder (201). The damping cylinder (100) can also include a piston (203) coupled to the piston rod (103). The piston (203) is movable within the piston cylinder (201) and separates the piston cylinder (201) into a first fluid chamber (210) and a second fluid chamber (211). The damping cylinder (100) can further include a damping module (102) in fluid communication with the first and second fluid chambers (210, 211). The damping module (102) includes a pressure relief valve (221) configured to provide a first damping level and a directional control valve (222) configured to provide at least a second damping level.

### TECHNICAL FIELD

The present invention relates to, damping cylinders, and more particularly, to a passive damping cylinder including one or more damping levels.

### BACKGROUND OF THE INVENTION

Damping cylinders are well known and can be used to dampen the relative movement between two components. Damping cylinders are widely used in vehicle applications. One of the most common uses of damping cylinders is in the suspension system of a vehicle, such as a car or a bus. In general, the damping cylinder is connected to a vehicle at two points that are movable with respect to one another.

The damping cylinder generally contains a damping fluid that can flow between two separate chambers of the damping cylinder in response to movement of the movable part relative to the stationary part. The damping fluid typically comprises hydraulic oil; however, other fluids such as water, compressed air, etc. may be used depending on the particular application. The damping cylinder also typically includes some means to restrict flow either into or out of the damping cylinder during movement in order to dampen or slow the movement of the movable part of the vehicle. This dampening can improve the performance of a vehicle's joints during turns as well as while moving in a straight path.

Prior art damping cylinders are faced with a number of problems. One problem is the complex external piping from the cylinder to an external fluid supply and attachments provided for delivering the damping fluid to and from the damping cylinder. Many prior art damping cylinders are supplied with the damping fluid from a damping fluid reservoir that is located remotely from the interior of the damping cylinder. Therefore, piping is required to communicate the damping fluid to and from the internal chambers of the damping cylinder. Each pipefitting comprises a potential leak point.

Many damping cylinders are designed so that the connection between the first and the second fluid chambers is located external of the cylinder. This external connection results in a potential leak point of the system.

The present invention overcomes these and other problems and an advance in the art is achieved. The present invention provides a self-sufficient damping cylinder with an adjustable damping level. The damping level of the system can be adjusted using one or more directional control valves. The present invention does not require an external fluid supply, but rather provides a passive damping cylinder with an integrated damping fluid reservoir. The location of the damping fluid reservoir within the cylinder reduces the potential for leaks to occur.

### SUMMARY OF THE INVENTION

A damping cylinder is provided according to an embodiment of the invention. The damping cylinder comprises a housing and a piston cylinder located at least partially within the housing. A piston rod extends from the piston cylinder and the housing. According to an embodiment of the invention, the damping cylinder further includes a piston coupled to the piston rod and movable within the piston cylinder. The piston further separates the piston cylinder into a first fluid chamber and a second fluid chamber. According to an embodiment of the invention, a damping module in fluid communication with the first and second fluid chambers is also provided. The damping module includes a pressure relief valve configured to provide a first damping level and a directional control valve configured to provide at least a second damping level.

A method for operating a damping cylinder including a housing, a piston cylinder located at least partially within the housing, a piston rod extending from the piston cylinder and the housing, and a piston coupled to the piston rod that is movable within the piston cylinder and separates the piston cylinder into a first fluid chamber and a second fluid chamber is provided according to an embodiment of the invention. The method comprises a step of dampening movement of the piston within the piston cylinder at a first damping level by directing a damping fluid through a pressure relief valve as the damping fluid flows between the first and second chambers during movement of the piston. The method further comprises a step of dampening movement of the piston within the housing at one or more additional damping levels by actuating a directional control valve to direct the damping fluid through the directional control valve as the damping fluid flows between the first and second fluid chambers during movement of the piston.

### ASPECTS

According to an aspect of the invention, a damping cylinder comprises:
a housing;
a piston cylinder located at least partially within the housing
a piston rod extending from the piston cylinder and the housing;
a piston coupled to the piston rod and movable within the piston cylinder and separating the piston cylinder into a first fluid chamber and a second fluid chamber;
a damping module in fluid communication with the first and second fluid chambers and including:
   a pressure relief valve configured to provide a first damping level; and
   a directional control valve configured to provide at least a second damping level.

Preferably, the damping cylinder further comprises a damping fluid reservoir in fluid communication with the first and second fluid chambers via fluid lines and in fluid communication with the damping module via another fluid line, wherein the fluid lines are located within the housing.

Preferably, the damping cylinder further comprises a check valve positioned in a fluid line providing fluid communication between the damping fluid reservoir and the first fluid chamber.

Preferably, the damping cylinder further comprises a check valve positioned in a fluid line providing fluid communication between the damping fluid reservoir and the second fluid chamber.

Preferably, the damping fluid reservoir is located within the housing.

Preferably, the damping cylinder further comprises a check valve in a fluid line providing fluid communication between the first fluid chamber and the damping module.

Preferably, the damping cylinder further comprises a check valve in a fluid line providing fluid communication between the second fluid chamber and the damping module.

Preferably, the damping module further includes a throttle located downstream of the pressure relief valve and in fluid communication with the damping fluid reservoir.

Preferably, a cross-sectional area of at least one of a plurality of fluid lines providing fluid communication between the damping module and the first and second fluid chambers and the damping fluid reservoir at least partially determine the first and second damping levels.

According to another aspect of the invention, a method for operating a damping cylinder including a housing, a piston cylinder located at least partially within the housing, a piston rod extending from the piston cylinder and the housing, and a piston coupled to the piston rod that is movable within the piston cylinder and separates the piston cylinder into a first fluid chamber and a second fluid chamber is provided, the method comprises steps of:
dampening movement of the piston within the piston cylinder at a first damping level by directing a damping fluid through a pressure relief valve as the damping fluid flows between the first and second chambers during movement of the piston; and
dampening movement of the piston within the housing at one or more additional damping levels by actuating a directional control valve to direct the damping fluid through the directional control valve as the damping fluid flows between the first and second fluid chambers during movement of the piston.

Preferably, the method further comprises a step of directing the damping fluid into a damping fluid reservoir as the damping fluid flows between the first and second fluid chambers.

Preferably, the method further comprises a step of directing the damping fluid through a check valve positioned between the damping fluid reservoir and the first fluid chamber.

Preferably, the method further comprises a step of directing the damping fluid through a check valve positioned between the damping fluid reservoir and the second fluid chamber.

Preferably, the method further comprises a step of directing the damping fluid through a check valve positioned between the first fluid chamber and the throttle.

Preferably, the method further comprises a step of directing the damping fluid through a check valve positioned between the second fluid chamber and the throttle.

Preferably, the method further comprises a step of directing the damping fluid through a throttle located in parallel with the pressure relief valve if the pressure in either the first or the second fluid chambers falls below a threshold pressure.

### BRIEF DESCRIPTION OF THE DRAWINGS

FIG. 1 shows a damping cylinder according to an embodiment of the invention.

FIG. 2 shows an end view of the damping cylinder with a portion of the end removed to expose the interior according to an embodiment of the invention.

FIG. 3 shows a cross-sectional view of the damping cylinder according to an embodiment of the invention.

FIG. 4 shows another cross-sectional view of the damping cylinder according to an embodiment of the invention.

FIG. 5 shows a schematic of the damping cylinder according to another embodiment of the invention.

FIG. 6 shows a schematic of the damping cylinder when a force is applied to the cylinder in a first direction according to an embodiment of the invention.

FIG. 7 shows a schematic of the damping cylinder when a force is applied to the cylinder in a second direction according to an embodiment of the invention.

### DETAILED DESCRIPTION OF THE INVENTION

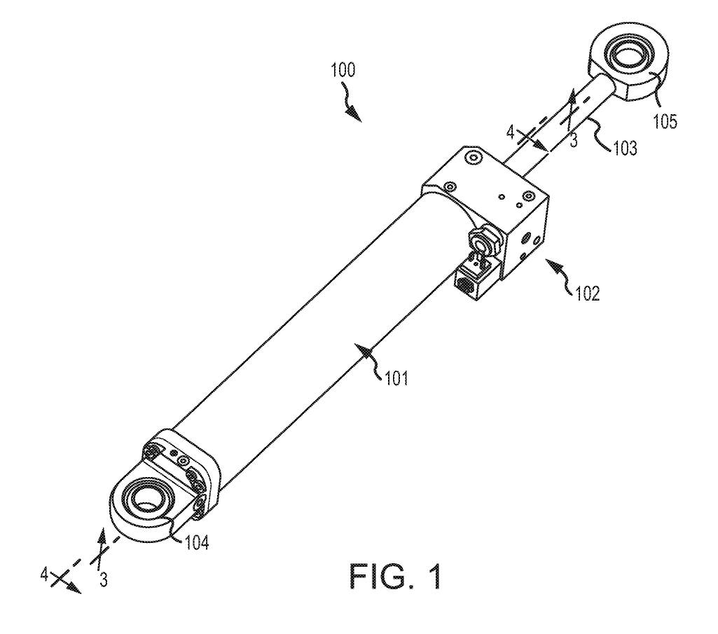

FIGS. 1-7 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 shows a damping cylinder 100 according to an embodiment of the invention. The damping cylinder 100 comprises an outer housing 101 in the form of a tank tube, a damping module 102, and a piston rod 103 extending from the outer housing 101. The damping cylinder 100 further comprises a first eyelet 104 and a second eyelet 105. The first and second eyelets 104, 105 can be provided to attach the damping cylinder 100 to the device (not shown) with which the damping cylinder 100 is utilized. For example, if the damping cylinder 100 is used in combination with a vehicle, the first eyelet 104 could be coupled to a vehicle chassis, while the second eyelet 105 could be coupled to a movable portion of the vehicle, such as a movable body part or the like. It should be appreciated however, that the damping cylinder 100 could be used in other applications where damping of movement between two components is desired. Therefore, the particular invention should not be limited to use in combination with vehicles.

As mentioned above, the damping cylinder 100 also includes a damping module 102. As described in more detail below, the damping module 102 can comprise at least a valve and a throttle that can be used separately or in combination to adjust the dampening of the piston rod 103 with respect to the housing 101.

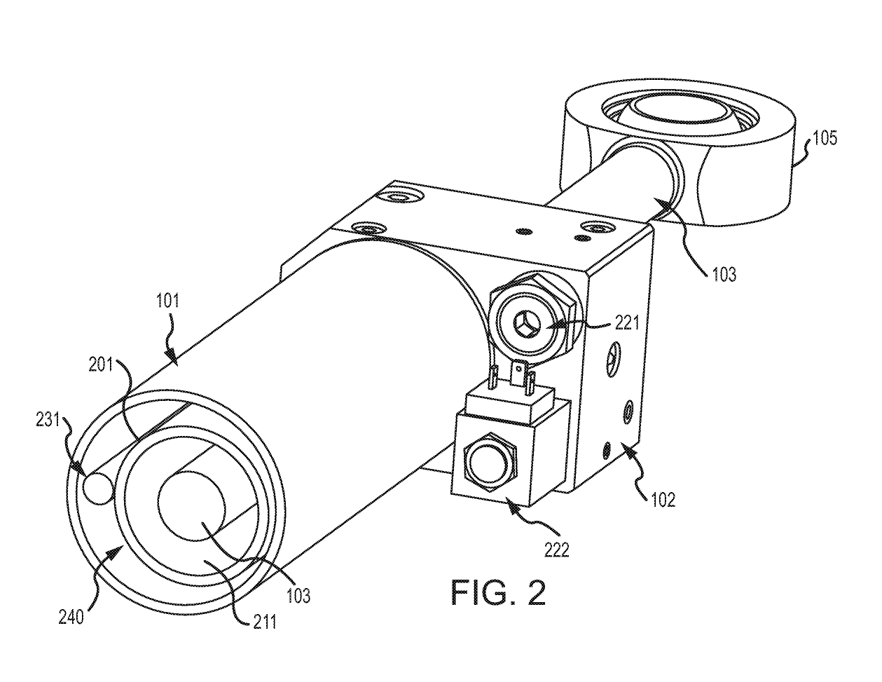

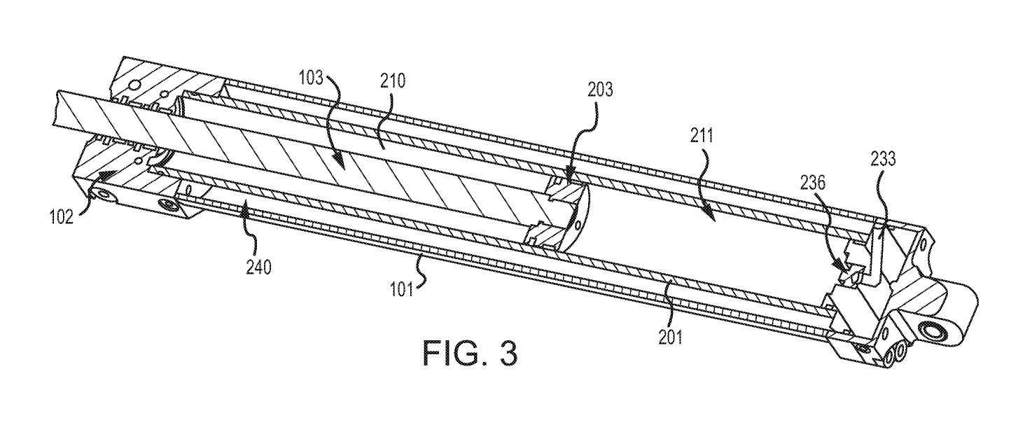

FIG. 2 shows an end view of the damping cylinder 100 according to an embodiment of the invention. In the embodiment shown in FIG. 2, the end of the damping cylinder 100 proximate the first eyelet 104 is removed to expose a portion of the interior of the outer housing 101. As shown in FIG. 2, the damping cylinder 100 further comprises a piston cylinder 201 located at least partially within the outer housing 101. The piston cylinder 201 includes a piston (See FIG. 3) with the piston rod 103 coupled to the piston. The piston separates the piston cylinder 201 into a first fluid chamber 210 (See FIG. 3) and a second fluid chamber 211.

According to an embodiment of the invention, a damping fluid reservoir 240 is provided for retaining a damping fluid. According to the embodiment shown, the damping fluid reservoir 240 is at least partially defined by an interior surface of the outer housing 101 and an exterior surface of the piston cylinder 201. Advantageously, the damping cylinder 100 comprises a self-contained damping fluid reservoir 240.

Also shown in FIG. 2 is a portion of a fluid line 231. In the embodiment shown, the fluid line 231 is located within the outer housing 101. The fluid line 231 can provide fluid communication between the second fluid chamber 211 and the damping module 102 as explained in detail below.

Additionally shown in FIG. 2 are a pressure relief valve 221 and a directional control valve 222. The pressure relief valve 221 and the directional control valve 222 are described further below.

FIG. 3 shows a cross-sectional view of the damping cylinder 100 taken along line 3-3 of FIG. 1. As shown in FIG. 3, the damping cylinder 100 comprises the outer housing 101, with the piston cylinder 201 being positioned within the outer housing 101. The damping fluid reservoir 240 is shown being at least partially defined by the outer surface of the piston cylinder 201 and the inner surface of the outer housing 101.

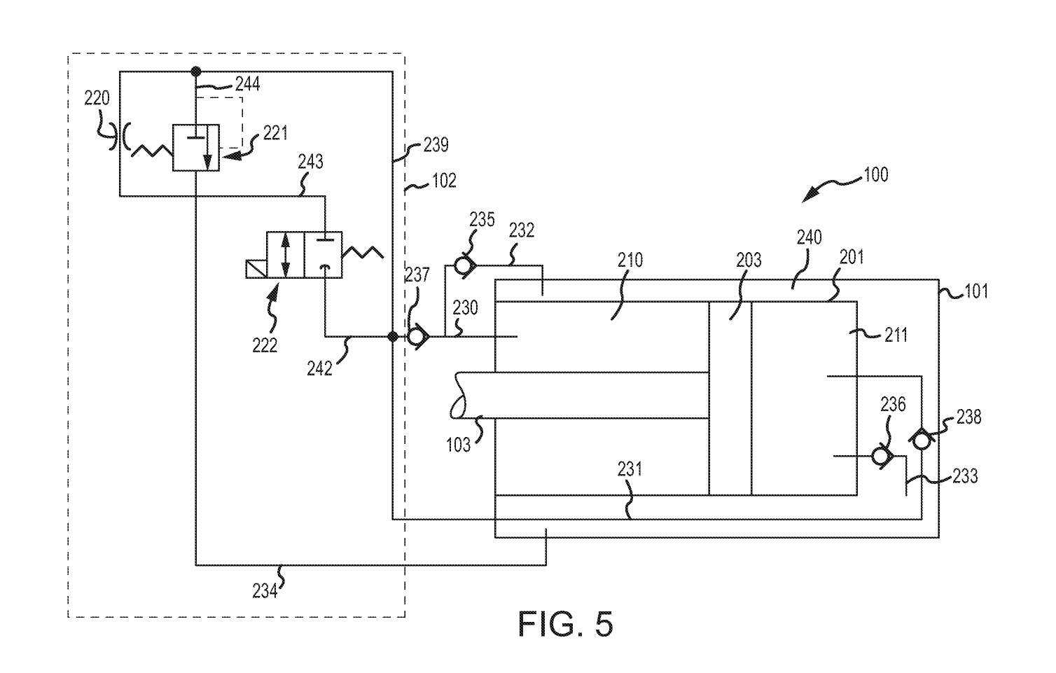

According to an embodiment of the invention, the damping cylinder 100 further comprises a piston 203 coupled to the piston rod 103 that forms a substantially fluid-tight seal with the piston cylinder 201 to separate the piston cylinder 201 into a first fluid chamber 210 and a second fluid chamber 211. The first and second fluid chambers 210, 211 can be filled with a damping fluid, such as hydraulic oil, for example. It should be appreciated however, that other fluids may be used as the damping fluid. Therefore, the present invention should not be limited to hydraulic oil. According to an embodiment of the invention, the first and second fluid chambers 210, 211 are in fluid communication with the damping module 102, which is shown coupled to the outer housing 101. The damping module 102 is shown schematically in FIG. 5 and described in more detail in the accompanying discussion.

Also shown in FIG. 3 are a fluid line 233 and a check valve 236. The fluid line 233 provides a fluid communication path between the damping fluid reservoir 240 and the second fluid chamber 211. According to an embodiment of the invention, the check valve 236 allows the damping fluid to flow from the damping fluid reservoir 240 to the second fluid chamber 211 but substantially prevents the damping fluid from flowing directly from the second fluid chamber 211 to the damping fluid reservoir 240.

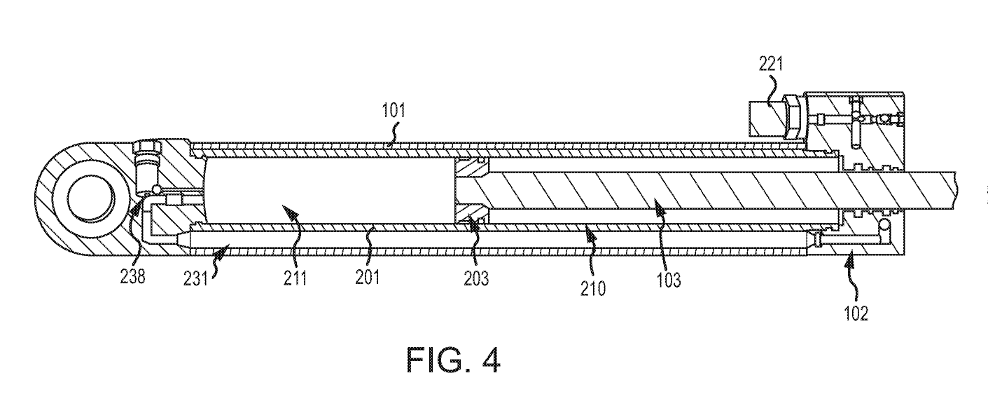

FIG. 4 shows a cross-sectional view of the damping cylinder 100 taken along line 4-4 of FIG. 1. As can be appreciated, the line 4-4 is rotated approximately 180° with respect to the line 3-3. Therefore, FIG. 4 shows components of the damping cylinder 100 that were not visible in FIG. 3. However, additional features that are not visible in FIGS. 3 & 4 are depicted in the schematics provided by FIGS. 5-7. In addition to the components previously shown, FIG. 4 shows a fluid line 231. The fluid line 231 provides a fluid communication path between the second fluid chamber 211 and the damping module 102. The fluid line 231 can include a check valve 238. The check valve 238 allows the damping fluid to flow from the second fluid chamber 211 to the damping module 102, but substantially prevents the damping fluid from flowing from the damping module 102 or the first fluid chamber 210 directly to the second fluid chamber 211. As can be seen, the fluid line 231 is positioned within the outer housing 101. Therefore, if a leak occurs in the fluid line 231, the fluid is retained within the outer housing 101. Operation and further features of the damping cylinder 100 are shown in the schematics of the damping cylinder 100 and the description that follows.

FIG. 5 shows a schematic of the damping cylinder 100 according to an embodiment of the invention. According to an embodiment of the invention, the damping module 102 is shown comprising a throttle 220, a one-way pressure relief valve 221, and a directional control valve 222. The first and second fluid chambers 210, 211 are shown in fluid communication with the damping module 102 via fluid lines 230, 231. Furthermore, the first and second fluid chambers 210, 211 are in fluid communication with a common damping fluid reservoir 240. The fluid lines 232-234 in fluid communication with the reservoir 240 are shown ending within the outer housing 101, which forms the outer barrier of the fluid reservoir 240. The fluid reservoir 240 may be at a predetermined pressure. Using a common damping fluid reservoir results in a self-sufficient system that does not require an external damping fluid supply. According to another embodiment of the invention, the damping fluid reservoir 240 may comprise a chamber that substantially surrounds the first and second fluid chambers 210, 211, but is within the housing 101. Alternatively, the damping fluid reservoir 240 may comprise a chamber within the housing 101 that is positioned proximate one of the first or second fluid chambers 210, 211 without surrounding either of the chambers 210, 211. Advantageously, in either configuration, separate fluid lines are not required to extend from the housing 101, thereby reducing the potential for fluid leaking.

According to an embodiment of the invention, the first fluid chamber 210 is in fluid communication with the damping fluid reservoir 240 via the fluid lines 230 and 232. As shown, in some embodiments, the fluid line 232 can include a check valve 235. The check valve 235 allows the damping fluid to flow from the damping fluid reservoir 240 to the first fluid chamber 210, but substantially prevents fluid from flowing directly from the first fluid chamber 210 to the damping fluid reservoir 240. Similarly, the second fluid chamber 211 is in fluid communication with the damping fluid reservoir 240 via a fluid line 233. As shown, in some embodiments, the fluid line 233 can include a check valve 236. The check valve 236 allows the damping fluid to flow from the damping fluid reservoir 240 to the second fluid chamber 211 but substantially prevents the damping fluid from flowing directly from the second fluid chamber 211 to the damping fluid reservoir 240. With the check valves 235, 236 in place, an increase in pressure in either of the fluid chambers 210, 211 is substantially prevented from flowing directly into the damping fluid reservoir 240 and increasing the pressure of the damping fluid reservoir 240. The check valves 235, 236 can also prevent an increase in pressure in one of the fluid chambers 210, 211 from flowing to the other fluid chamber via the damping fluid reservoir 240 without passing through the damping module 102.

According to an embodiment of the invention, the first fluid chamber 210 is also in fluid communication with the damping module 102 via the fluid line 230. According to the embodiment shown in FIG. 5, the fluid line 230 includes a check valve 237. The check valve 237 allows the damping fluid to flow from the first fluid chamber 210 to the damping module 102, but substantially prevents fluid from flowing from the damping module 102 or the second fluid chamber 211 directly to the first fluid chamber 210. Similarly, the second fluid chamber 211 is in fluid communication with the damping module 102 via the fluid line 231. According to the embodiment shown in FIG. 5, the fluid line 231 includes a check valve 238. The check valve 238 allows the damping fluid to flow from the second fluid chamber 211 to the damping module 102, but substantially prevents the damping fluid from flowing from the damping module 102 or the first fluid chamber 210 directly to the second fluid chamber 211. In order for the damping fluid to flow from one fluid chamber to the other with the check valves 237, 238 in place, the damping fluid is required to flow through the damping module 102. According to an embodiment of the invention, substantially all of the fluid lines 230, 231, 232, and 233 are located within the housing 101 and/or the damping module 102. This prevents fluid from escaping from the damping cylinder 100 in the event of a leak in a fluid line.

As mentioned briefly above, according to an embodiment of the invention, the damping module 102 comprises a throttle 220, a one-way pressure relief valve 221, and one or more directional control valves 222. The one or more directional control valves 222 may be used to adjust the flow restriction provided by the damping module 102, i.e., the level of damping provided by the damping module 102. According to an embodiment of the invention, if the directional control valve 222 is de-actuated, i.e., closed, the damping module 102 provides a first level of damping. Conversely, if the directional control valve 222 is actuated, the damping module 102 provides at least a second level of damping. Those skilled in the art will also appreciate that the level of damping regardless of the actuation state of the directional control valve 222 is at least partially determined by the cross-sectional area of the fluid lines 230, 231, 232, 233, 234, 239, 242, 243, and 244. Therefore, the cross-sectional area of the fluid lines can be chosen based on a desired level of damping.

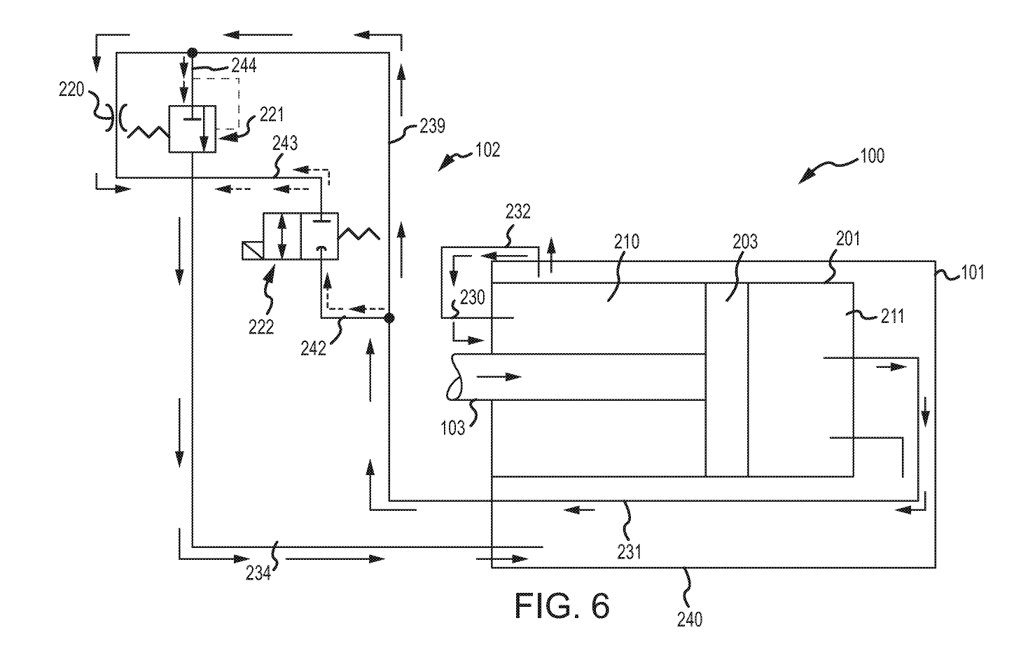

Attention is now drawn to FIGS. 6 & 7, which depict simplified versions of FIG. 5 showing only the fluid lines where fluid flow is present during specific movements of the piston rod 103 and the piston 203. In use, the first and second fluid chambers 210, 211 are pressurized with the damping fluid from the common damping fluid reservoir 240. As can be appreciated, at equilibrium, the piston rod 103 and the piston 203 are substantially stationary and the pressure within the first and second fluid chambers 210, 211 are substantially equal. The equilibrium pressure can be maintained by the common damping fluid reservoir 240, which may be at a predetermined pressure, which can be maintained by allowing fluid to flow through the nozzle 220 to equilibrate the pressures in the first and second fluid chambers 210, 211. An externally applied force may be provided on the piston rod 103, which may vary due to a variety of different conditions. For example, if the damping cylinder 100 is utilized in a suspension system of a vehicle, the external force applied to the piston rod 103 may be due to a change in the position of a vehicle' s wheel with respect to the vehicle chassis as the vehicle travels over uneven ground. As discussed above, a suspension spring (not shown) or other biasing member may be used in combination with the damping cylinder 100 to provide a neutral position at which the damping cylinder 100 is at equilibrium and thus, the external force is removed from the piston rod 103 or below a threshold level.

FIG. 6 shows the damping cylinder 100 when the force acting on the piston rod 102 is in a first direction (to the right as shown in FIG. 6). As the piston 203 is pushed to the right, the volume of the second fluid chamber 211 decreases, which thereby increases the pressure within the second fluid chamber 211. Simultaneously, the volume of the first fluid chamber 210 increases resulting in a decrease in the pressure in the first fluid chamber 210. The increase in pressure within the second fluid chamber 211 causes at least some of the damping fluid to flow out of the second fluid chamber 211 and into the fluid line 231. The damping fluid in the fluid line 231 will flow towards the damping module 102 as shown by the arrows.

According to an embodiment of the invention, the directional control valve 222 may be biased to a default, or a de-actuated, position. According to an embodiment of the invention, when the directional control valve 222 is in the default position, the fluid flow path through the valve 222 is closed. With the directional control valve 222 de-actuated, the damping fluid in the fluid line 231 can only flow to the fluid line 239 as shown by the solid arrows. The check valve 237 (not shown in FIG. 6) substantially prevents the damping fluid from flowing directly into the first fluid chamber 210. According to an embodiment of the invention, the damping fluid flows from the fluid line 239 to the throttle 220. The throttle 220 substantially restricts the flow rate of the damping fluid, thereby increasing the pressure in the line 239. The throttle 220 may comprise a nozzle, a Venturi, an orifice, or the like, which at least temporarily, reduces the cross-sectional area of the line 239, thereby restricting the flow of the damping fluid through the line 239. While some of the fluid can flow through the throttle 220 and to the fluid line 234 where it can enter the damping fluid reservoir 240, some of the fluid will also cause the pressure relief valve 221 to open via a fluid line 244 that branches off from line 239 thereby allowing fluid to flow through the fluid line 244 to the line 234. The pressure at which the pressure relief valve 221 opens at least partially determines the first damping level. This is because, with the pressure relief valve 221 set at a predetermined pressure, the pressure relief valve 221 will close if the pressure in the fluid line 239, and thus, the force acting on the piston rod 103 drops below a predetermined pressure. According to one embodiment, the threshold pressure at which the pressure relief valve 221 opens may be set to approximately 130 bar (1886 psi); however, it should be appreciated that 130 bar (1886 psi) is merely one example and the pressure relief valve 221 may be configured to open at other pressures while remaining within the scope of the present invention. When the pressure relief valve 221 closes, fluid can still flow from the second fluid chamber 211 to the damping fluid reservoir 240 via the throttle 220 to allow the system to reach an equilibrium pressure between the first and second fluid chambers 210, 211. After flowing through the throttle 220 and the pressure relief valve 221, the damping fluid is substantially prevented from flowing into the fluid line 243 due to the closed valve 222.

Although the damping fluid flows from the fluid line 234 into the damping fluid reservoir 240, the pressure within the damping fluid reservoir 240 remains substantially constant because the additional damping fluid can simply flow from the damping fluid reservoir 240 into the first fluid chamber 210 as shown in FIG. 6. According to an embodiment of the invention, substantially the same amount of damping fluid that exits the second fluid chamber 211 enters the first fluid chamber 210 during movement of the piston 203. However, as can be appreciated, due to the throttle 220 and the pressure relief valve 221, the rate at which the damping fluid can exit and enter the fluid chambers 211, 210, respectively, is limited based on a predetermined applied force to the piston rod 103.

As can be appreciated, the embodiment described above utilizes the damping module 102 to provide a first damping level for the damping cylinder 100. Therefore, movement of the piston rod 103 and the piston 203 is limited to a predetermined speed based on a predetermined force acting on the piston rod 103. If a user or operator desires to increase the speed of the piston rod 103 and the piston 203 for a predetermined force acting on the piston rod 103 (decrease the damping level), the one or more directional control valves 222 may be actuated, which results in the damping module 102 providing at least a second damping level.

According to an embodiment of the invention, the at least second damping level can be provided by actuating the directional control valve 222. Those skilled in the art will readily appreciate that more than one directional control valve 222 may be provided in order to provide more than a second damping level. The directional control valve 222 may be actuated in a variety of manners. In the embodiment shown in FIG. 5, the directional control valve 222 comprises a solenoid-actuated valve; however, it should be appreciated that the valve 222 may be actuated according to other well-known principles, such as using a pilot pressure, for example.

According to an embodiment of the invention, with the directional control valve 222 actuated, at least a portion of the fluid that was previously directed into the fluid line 239 and through the throttle 220 and pressure relief valve 221 can be directed into the fluid line 242 as shown by the dashed arrows, through the valve 222, and into fluid line 243 where it combines with the damping fluid flowing out of the throttle 220 and exits the damping module 102 through the line 234. According to an embodiment of the invention, the size of the flow path provided by the directional control valve 222 can be varied in order to adjust the damping level of the damping module 102 with the valve 222 actuated. For example, in some embodiments, the valve 222 may comprise a proportional valve that can be adjusted to various positions between fully open and fully closed. Alternatively, the valve 222 may comprise a solenoid-actuated valve that can be held between fully open and fully closed using a pulse width modulation signal supplied to the solenoid. As can be appreciated, with the directional control valve 222 actuated, the speed at which the damping fluid can flow through the damping module 102 is increased, thereby lowering the damping level provided. With the damping level lowered, the speed at which a predetermined force can move the piston rod 103 and the piston 203 can be increased.

Once the external force acting on the piston rod 103 decreases to a threshold level, movement of the piston rod 103 will stop as the pressure within the first and second fluid chambers 210, 211 equalizes. According to some embodiments, the external force acting on the piston rod 103 may reverse directions and apply a force to the piston rod 103 in a second direction, substantially opposite the first direction, thereby pulling the piston rod 103 away from the housing 101. This movement may occur due to the steering movement in a vehicle as is generally known in the art. This movement will simultaneously pull the piston rod 103 away from the housing 101. According to an embodiment of the invention, the damping module 102 also dampens the movement of the piston rod 103 as the piston rod 103 and piston 203 extend from the housing 101.

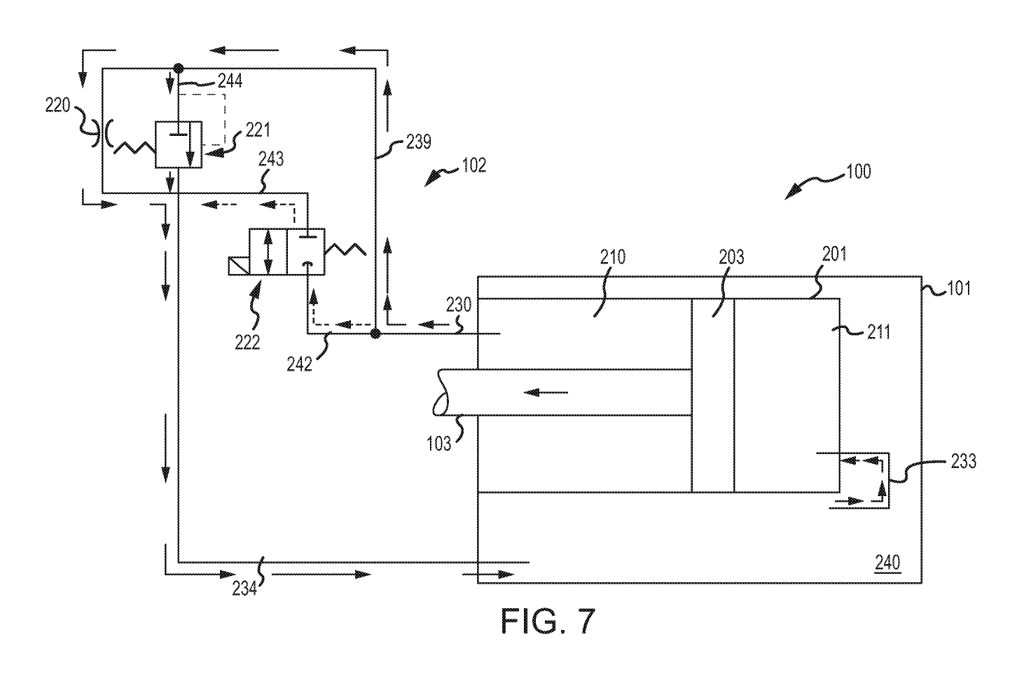

FIG. 7 shows a schematic of the damping cylinder 100 as a force is applied to the piston rod 103 in a second direction. According to an embodiment of the invention, as the piston 203 moves to the left as shown in the figures, the volume of the first fluid chamber 210 decreases and the volume of the second fluid chamber 211 increases. Consequently, the pressure in the first fluid chamber 210 increases and the pressure in the second fluid chamber 211 decreases. The increase in pressure in the first fluid chamber 210 results in at least some of the damping fluid flowing out of the first fluid chamber 210 and into the fluid line 230 and past the check valve 237 (not shown in FIG. 7) in order to once again obtain a pressure equilibrium between the first fluid chamber 210 and the second fluid chamber 211. If the directional control valve 222 is de-actuated, the fluid flows from the fluid line 230 into the fluid line 239 and passes through the throttle 220 and the pressure relief valve 221, as shown by the solid arrows. After flowing through the throttle 220 and the pressure relief valve 221, the damping fluid flows out of the damping module 102 through the fluid line 234 and into the damping fluid reservoir 240. The increase of damping fluid in the damping fluid reservoir 240 along with the decrease in the pressure in the second fluid chamber 211 causes damping fluid to flow from the damping fluid reservoir 240 into the second fluid chamber 211 via the fluid line 233 and the check valve 236 (not shown in FIG. 7) as shown by the solid arrows.

If the directional control valve 222 is actuated, at least some of the damping fluid exiting the first fluid chamber 210 can flow into the fluid line 242 and through the directional control valve 222 as shown by the dashed arrows. After flowing through the directional control valve 222, the damping fluid can recombine with the fluid leaving the throttle 220 via the fluid line 234.

The invention as described above provides a damping cylinder 100 capable of providing two or more damping levels. According to an embodiment of the invention, the damping cylinder 100 can include the damping module 102 described above that can dampen actuation of the damping cylinder's piston rod 103 regardless of the direction of movement. Advantageously, only one damping module is required for the damping cylinder 100. The damping cylinder 100 can comprise a self-sufficient system that does not require an external fluid supply. As shown, the damping fluid reservoir 240 as well as the various fluid lines can be located within an outer housing 101 that provides a fluid barrier in the event of a leak in any of the components located within the housing 101. Advantageously, the system can continue to operate without losing fluid to the environment.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention.

Thus, although specific embodiments of, and examples for, the invention are described herein for illustrative purposes, various equivalent modifications are possible within the scope of the invention, as those skilled in the relevant art will recognize. The teachings provided herein can be applied to other damping cylinders, and not just to the embodiments described above and shown in the accompanying figures. Accordingly, the scope of the invention should be determined from the following claims.

We claim:

1. A damping cylinder (100), comprising:
a housing (101);
a piston cylinder (201) located at least partially within the housing (101);
a piston rod (103) extending from the piston cylinder (201) and the housing (101);
a piston (203) coupled to the piston rod (103) and movable within the housing (101) and separating the piston cylinder (201) into a first fluid chamber (210) and a second fluid chamber (211);
a damping module (102) in fluid communication with the first and second fluid chambers (210, 211) and including:
a pressure relief valve (221) configured to provide a first damping level; and
a directional control valve (222) configured to provide at least a second damping level.

2. The damping cylinder (100) of claim 1, further comprising a damping fluid reservoir (240) in fluid communication with the first and second fluid chambers (210, 211) via fluid lines (232, 233) and in fluid communication with the damping module (102) via a fluid line (234), wherein the fluid lines (232, 233, 234) are located within the housing (101).

3. The damping cylinder (100) of claim 2, further comprising a check valve (235) positioned in a fluid line (232) providing fluid communication between the damping fluid reservoir (240) and the first fluid chamber (210).

4. The damping cylinder (100) of claim 2, further comprising a check valve (236) positioned in a fluid line (233) providing fluid communication between the damping fluid reservoir (240) and the second fluid chamber (211).

5. The damping cylinder (100) of claim 2, wherein the damping fluid reservoir (240) is located within the housing (101).

6. The damping cylinder (100) of claim 1, further comprising a check valve (237) in a fluid line (230) providing fluid communication between the first fluid chamber (210) and the damping module (102).

7. The damping cylinder (100) of claim 1, further comprising a check valve (238) in a fluid line (231) providing fluid communication between the second fluid chamber (211) and the damping module (102).

8. The damping cylinder (100) of claim 1, wherein the damping module (102) further includes a throttle (220) located in parallel with the pressure relief valve (221) and in fluid communication with the damping fluid reservoir (240).

9. The damping cylinder (100) of claim 1, wherein a cross-sectional area of at least one of a plurality of fluid lines (230, 231, 232, 233, 234, 239, 242, 243, 244) providing fluid communication between the damping module (102) and the first and second fluid chambers (210, 211) and the damping fluid reservoir (240) at least partially determine the first and second damping levels.

10. A method for operating a damping cylinder including a housing, a piston cylinder located at least partially within the housing, a piston rod extending from the piston cylinder and the housing, and a piston coupled to the piston rod that is movable within the piston cylinder and separates the piston cylinder into a first fluid chamber and a second fluid chamber, the method comprising steps of:
dampening movement of the piston within the piston cylinder at a first damping level by directing a damping fluid through a pressure relief valve as the damping fluid flows between the first and second chambers during movement of the piston; and
dampening movement of the piston within the piston cylinder at one or more additional damping levels by actuating a directional control valve to direct the damping fluid through the directional control valve as the damping fluid flows between the first and second fluid chambers during movement of the piston.

11. The method of claim 10, further comprising a step of directing the damping fluid into a damping fluid reservoir as the damping fluid flows between the first and second fluid chambers.

12. The method of claim 11, further comprising a step of directing the damping fluid through a check valve positioned between the damping fluid reservoir and the first fluid chamber.

13. The method of claim 11, further comprising a step of directing the damping fluid through a check valve positioned between the damping fluid reservoir and the second fluid chamber.

14. The method of claim 10, further comprising a step of directing the damping fluid through a check valve positioned between the first fluid chamber and the pressure relief valve.

15. The method of claim 10, further comprising a step of directing the damping fluid through a check valve positioned between the second fluid chamber and the pressure relief valve.

16. The method of claim 10, further comprising a step of directing the damping fluid through a throttle located in parallel with the pressure relief valve if the pressure in either the first or the second fluid chambers falls below a threshold pressure.
